(19) United States
(12) Patent Application Publication
(10) Pub. No.: US 2025/0345661 A1
(43) Pub. Date: Nov. 13, 2025

(54) GOLF BALL PAINT RESIN AND GOLF BALL

(71) Applicant: Sumitomo Rubber Industries, Ltd., Kobe-shi (JP)

(72) Inventors: Mami TANAKA, Kobe-shi (JP); Toshiyuki TARAO, Kobe-shi (JP); Takashi KAJIKAWA, Kobe-shi (JP); Yasuo NAITO, Kobe-shi (JP)

(73) Assignee: Sumitomo Rubber Industries, Ltd., Kobe-shi (JP)

(21) Appl. No.: 19/199,470

(22) Filed: May 6, 2025

(30) Foreign Application Priority Data
May 10, 2024 (JP) 2024-077299

(51) Int. Cl. A63B 37/00; C08G 18/32; C08G 18/42; C08G 18/48; C08G 18/66; C08G 18/72; C08G 18/73; C08G 18/75; C08G 18/78; C08G 18/79; C09D 175/06; C09D 175/08

(52) U.S. Cl. CPC A63B 37/00221; C08G 18/3206; C08G 18/4263; C08G 18/4854; C08G 18/6644; C08G 18/6677; C08G 18/725; C08G 18/73; C08G 18/755; C08G 18/7831; C08G 18/792; C09D 175/06; C09D 175/08; A63B 2209/00

(57) ABSTRACT

An object of the present disclosure is to provide a golf ball paint resin from which a golf ball having improved spin performance on approach shots (particularly improved spin performance on approach shots from the rough), excellent ball surface wear resistance, and excellent stain resistance to shots from the bunker can be obtained. The present disclosure provides a golf ball paint resin satisfying a relationship of 0.10≤ε1/M10≤1.00, wherein a test piece formed from the golf ball paint resin is deformed until a strain of the test piece becomes a predetermined value εmax and then the deformation of the test piece is decreased until a stress of the test piece becomes 0 kgf/cm² in a tensile test conducted under the following test conditions, and M10 (kgf/cm²) is a stress at which a strain of the test piece is 10% during increase in the deformation, and ε1 (%) is a strain at which a stress of the test piece is 0 kgf/cm² during decrease in the deformation,

<Test Conditions>
dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%).

### FIELD OF THE DISCLOSURE

The present disclosure relates to a golf ball paint resin and a golf ball, and particularly relates to a technology for improving a paint film of a golf ball.

### DESCRIPTION OF THE RELATED ART

Conventionally, a paint film is formed on a surface of a golf ball body. It has been proposed to improve performance such as stain resistance or spin performance on approach shots of a golf ball by improving the paint film.

For example, JP 2022-158686 A discloses a golf ball comprising a golf ball body and a paint film composed of at least one layer and formed on a surface of the golf ball body, wherein an outermost layer of the paint film includes, as a base resin, a polyurethane obtained by a reaction between a polyisocyanate composition and a polyol composition, and the outermost layer of the paint film has a tackiness of less than 0.294 N measured with a friction tester under following conditions:

### Measurement Conditions

moving speed: 10 mm/s
load: 0.98 N, 1.96 N, 3.92 N
measuring item: a static friction force at each load is measured, a graph is plotted by having the load as a vertical axis and the static friction force as a horizontal axis, a linear approximation curve is obtained from this graph by a least square method, and an intercept value of the linear approximation curve is adopted as the tackiness.

JP 2022-158685 A discloses a golf ball comprising a golf ball body and a paint film composed of at least one layer and formed on a surface of the golf ball body, wherein an outermost layer of the paint film includes, as a base resin, a polyurethane obtained by a reaction between a polyisocyanate composition and a polyol composition, and the outermost layer of the paint film has a tackiness of 0.294 N or more measured with a friction tester under following conditions:

### Measurement Conditions

moving speed: 10 mm/s
load: 0.98 N, 1.96 N, 3.92 N
measuring item: a static friction force at each load is measured, a graph is plotted by having the load as a vertical axis and the static friction force as a horizontal axis, a linear approximation curve is obtained from this graph by a least square method, and an intercept value of the linear approximation curve is adopted as the tackiness.

JP 2021-137299 A discloses a golf ball comprising a golf ball body and a paint film composed of at least one layer and formed on a surface of the golf ball body, wherein at least one layer of the paint film includes a base resin and a porous filler, and the base resin includes a polyurethane obtained by a reaction between a polyisocyanate composition and a polyol composition containing, as a polyol component, a polyrotaxane having at least two hydroxyl groups and a urethane polyol.

JP 2021-137298 A discloses a golf ball comprising a golf ball body and a paint film composed of at least one layer and formed on a surface of the golf ball body, wherein at least one layer of the paint film includes, as a base resin, a polyurethane obtained by a reaction between a polyisocyanate composition and a polyol composition, the polyol composition contains, as a polyol component, a polyrotaxane having at least two hydroxyl groups and a urethane polyol, and an amount of the polyrotaxane having at least two hydroxyl groups in the polyol component is more than 0 mass % and less than 10 mass %.

### SUMMARY OF THE DISCLOSURE

The conventional golf balls are not necessarily satisfactory in the stain resistance or the spin performance on approach shots, and there is room for further improvement. In addition, a golf ball with a ball surface excellent in wear resistance is also required.

The present disclosure has been made in view of the above circumstances, and an object of the present disclosure is to provide a golf ball paint resin providing a golf ball having improved spin performance on approach shots (particularly improved spin performance on approach shots from the rough), excellent wear resistance of a ball surface, and excellent stain resistance on shots from a bunker.

The present disclosure that has solved the above problem provides a golf ball paint resin satisfying a relationship of 0.10≤ε1/M10≤1.00, wherein a test piece formed from the golf ball paint resin is deformed until a strain of the test piece becomes a predetermined value εmax and then the deformation of the test piece is decreased until a stress of the test piece becomes 0 kgf/cm² in a tensile test conducted under the following test conditions, and M10 (kgf/cm²) is a stress at which a strain of the test piece is 10% during increase in the deformation, and ε1 (%) is a strain at which a stress of the test piece is 0 kgf/cm² during decrease in the deformation.

### Test Conditions

dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%)

According to the present disclosure, the golf ball paint resin provides a golf ball having improved spin performance on approach shots (particularly improved spin performance on approach shots from the rough), excellent wear resistance of a golf ball surface, and excellent stain resistance on shots from the bunker.

### BRIEF DESCRIPTION OF THE DRAWINGS

FIG. 1 is a graph illustrating a stress-strain curve of a golf ball paint resin obtained by a tensile test.

FIG. 2 is a partially cutaway cross-sectional view showing a golf ball according to one embodiment of the present disclosure;

FIG. 3 is a schematic cross-sectional view illustrating a measuring location of a thickness of a paint film; and

FIG. 4 is a schematic cross-sectional view illustrating a measuring location of a thickness of a paint film.

### DESCRIPTION OF THE PREFERRED EMBODIMENT

The present disclosure provides a golf ball paint resin satisfying a relationship of 0.10≤ε1/M10≤1.00, wherein a test piece formed from the golf ball paint resin is deformed until a strain of the test piece becomes a predetermined value εmax and then the deformation of the test piece is decreased until a stress of the test piece becomes 0 kgf/cm² in a tensile test conducted under the following test conditions, and M10 (kgf/cm²) is a stress at which a strain of the test piece is 10% during increase in the deformation, and ε1 (%) is a strain at which a stress of the test piece is 0 kgf/cm² during decrease in the deformation.

### Test Conditions

dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%)

The present inventors find that if the resin satisfying the above specific relationship in the stress-strain curve obtained by the tensile test is used as the golf ball paint resin, the golf ball has improved spin performance on approach shots (particularly improved spin performance on approach shots from the rough), excellent wear resistance of a golf ball surface, and excellent stain resistance on shots from the bunker.

The reason why if the resin satisfying the above specific relationship is used as a base resin of a paint film of a golf ball, the golf ball has improved spin performance on approach shots (particularly improved spin performance on approach shots from the rough), excellent wear resistance of a golf ball surface, and excellent stain resistance on shots from the bunker, is not clear, but it is considered as follows. The paint film of the golf ball according to the present disclosure has a strong power to return to the original state even if it deforms on bunker shots. Thus, the stain such as sand, soil or grass juice hardly enters into the paint film, and the stain is easily removed even if the surface of the paint film is stained.

First, the tensile test method for the golf ball paint resin according to the present disclosure will be explained.

As the test piece for the tensile test, a strip-shaped test piece having a dimension with a width of 4 mm, a length of 20 mm or more, and a thickness of 100 μm±10 μm is prepared. It is noted that the length of the test piece is not particularly limited, as long as the test piece has a length such that the distance between clamps when conducting the tensile test is 20 mm, but the length of the test piece is more preferably 25 mm or more and 35 mm or less.

The tensile tester is not particularly limited, and a dynamic viscoelasticity measuring apparatus is preferably used. Examples of the dynamic viscoelasticity measuring apparatus include Rheogel-E4000 available from UBM CO., Ltd.

The tensile test is preferably conducted according to the following procedure.

1) The strip-shaped test piece is gripped with the clamps, and the clamps are moved in a direction of increasing the deformation of the test piece to elongate the test piece until the strain of the test piece becomes the predetermined value εmax. The distance between the clamps is 20 mm. The tensile speed during increase in the deformation is 1.1 mm/second. The stress M10 (kgf/cm²) at which the strain of the test piece is 10% during increase in the deformation, and the stress M50 (kgf/cm²) at which the strain of the test piece is the predetermined value εmax (εmax=50%) during increase in the deformation are recorded respectively.

2) When the strain of the test piece reaches the predetermined value εmax, the clamps are immediately returned in a direction of decreasing the deformation of the test piece. The returning speed during decrease in the deformation is 1.1 mm/second.

3) The strain ε1 at which the stress of the test piece becomes 0 is recorded.

4) The temperature of the tensile test is 23° C., and the data acquisition points per second are 50.

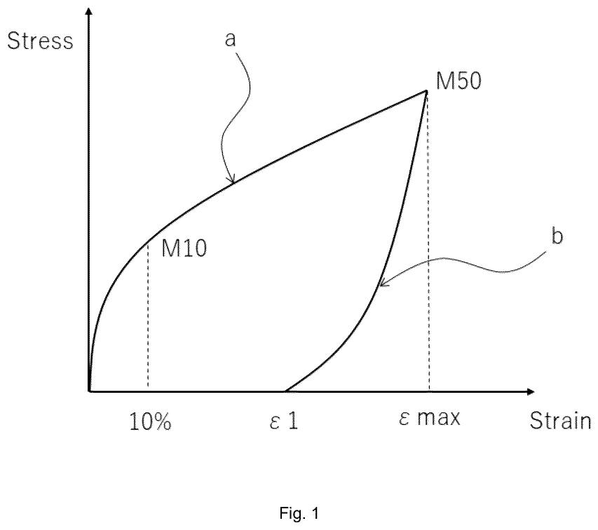

FIG. 1 is a schematic graph of one example of a stress-strain curve obtained by the tensile test of the present disclosure. The curve “a” is a stress-strain curve obtained by moving the clamps in the direction of increasing the deformation of the test piece to elongate the test piece until the strain of the test piece becomes the predetermined value εmax (i.e. obtained during increase in the deformation). In the present disclosure, M10 is the stress at which the strain is 10%, and M50 is the stress at which the strain is the predetermined value εmax (εmax=50%) in the curve “a”. The curve “b” is a stress-strain curve obtained by moving the clamps in the direction of decreasing the deformation of the test piece after the strain of the test piece reaches the predetermined value εmax (i.e. obtained during decrease in the deformation). At the intersection of the curve b with the X-axis, the stress of the test piece is 0. In the present disclosure, the strain at this intersection is ε1.

It is noted that ε1 is shown to be greater than 10% (ε1>10%) in FIG. 1, but ε1 may also be equal to 10% (ε1=10%) or lower than ε1 (ε1<10%).

In the present disclosure, the strain ε is represented by the following formula.

$$Strain ε ( \% ) = 100 \times Δ L / L$$

In the formula, L is the distance between the clamps (i.e. the length of the test piece between the clamps) before applying a load to the test piece, and ΔL is the displacement amount during the deformation.

In the tensile test of the present disclosure, the test piece is elongated in the direction of increasing the deformation of the test piece until the strain of the test piece becomes the predetermined value εmax (εmax=50%), and when the strain of the test piece reaches the predetermined value εmax (εmax=50%), the clamps are returned in the direction of decreasing the deformation of the test piece.

The golf ball paint resin according to the present disclosure preferably satisfies the relationship of 0.10≤ε1/M10≤1.00, wherein the test piece formed from the golf ball paint resin is deformed until the strain of the test piece becomes the predetermined value max (εmax=50%) and then the deformation of the test piece is decreased until the stress of the test piece becomes 0 kgf/cm² in the tensile test, and M10 (kgf/cm²) is the stress at which the strain of the test piece is 10% during increase in the deformation, and ε1 (%) is the strain at which the stress of the test piece is 0 kgf/cm² during decrease in the deformation. The ε1/M10 is preferably 0.20 or more, more preferably 0.40 or more, and is preferably 0.95 or less, more preferably 0.90 or less.

The strain value (ε1) of the golf ball paint resin according to the present disclosure at which the stress becomes 0 kgf/cm₂ in the tensile test is preferably 40% or less, more preferably 38% or less, and even more preferably 36% or less. In addition, the strain value (ε1) is not particularly limited, and it is preferably 0% or more, more preferably 1% or more.

The stress M10 (also referred to as “10% elastic modulus”) of the golf ball paint resin according to the present disclosure at which the strain is 10% in the tensile test is preferably 5 kgf/cm² (0.49 MPa) or more, more preferably 10 kgf/cm² (0.98 MPa) or more, and even more preferably 15 kgf/cm² (1.47 MPa) or more, and is preferably 100 kgf/cm² (9.80 MPa) or less, more preferably 95 kgf/cm² (9.31 MPa) or less, and even more preferably 90 kgf/cm² (8.82 MPa) or less. If the stress M10 is 5 kgf/cm² or more and 100 kgf/cm² or less, the shot feeling of the golf ball hit with a putter is better.

The stress M50 (also referred to as “50% elastic modulus”) of the golf ball paint resin according to the present disclosure at which the strain is the predetermined value εmax (εmax=50%) in the tensile test is preferably 10 kgf/cm² or more, more preferably 20 kgf/cm² or more, and even more preferably 30 kgf/cm² or more, and is preferably 150 kgf/cm² or less, more preferably 140 kgf/cm² or less, and even more preferably 130 kgf/cm² or less. If the stress M50 falls within the above range, the shot feeling of the golf ball hit with a putter is better.

The tensile properties of the golf ball paint resin according to the present disclosure can be controlled by adjusting, for example, the type or amount of the constituent components of the golf ball paint resin.

The golf ball paint resin according to the present disclosure preferably comprises a polyurethane as a resin component. The amount of the polyurethane in the resin component is preferably 50 mass % or more, more preferably 70 mass % or more, and even more preferably 90 mass % or more. It is also preferable that the resin component of the paint substantially consists of the polyurethane.

The polyurethane is a polymer having a plurality of urethane bonds in the main chain. The polyurethane used in the present disclosure is preferably a polyurethane obtained by a reaction between a polyisocyanate composition containing a polyisocyanate and a polyol composition containing a polyol. A plurality of urethane bonds are formed in the main chain of the polyurethane through the reaction between the polyisocyanate and the polyol. The obtained polyurethane includes the polyisocyanate component derived from the polyisocyanate, and the polyol component derived from the polyol.

Examples of the polyol component constituting the polyurethane include a low molecular weight polyol having a molecular weight of less than 400, and a high molecular weight polyol having a number average molecular weight of 400 or more.

Examples of the high molecular weight polyol include a polyether polyol, a polyester polyol, a polycaprolactone polyol, a polycarbonate polyol, and an acrylic polyol. Examples of the polyether polyol include polyoxyethylene glycol (PEG), polyoxypropylene glycol (PPG), and polyoxytetramethylene glycol (PTMG).

Examples of the polyether polyol include polyethylene adipate (PEA), polybutylene adipate (PBA), and polyhexamethylene adipate (PHMA). Examples of the polycaprolactone polyol include poly-ε-caprolactone (PCL). Examples of the polycarbonate polyol include polyhexamethylene carbonate. The high molecular weight polyol may be used solely, or two or more of them may be used in combination.

Examples of the low molecular weight polyol include a diol such as ethylene glycol, diethylene glycol, triethylene glycol, 1,3-butanediol, 1,4-butanediol, neopentyl glycol, and 1,6-hexanediol; and a triol such as glycerin, trimethylolpropane, and hexanetriol. The low molecular weight polyol may be used solely or as a mixture of at least two of them.

The polyurethane comprised in the paint resin according to the present disclosure preferably includes the polycarbonate diol as the polyol component.

The polycarbonate diol is preferably a liquid polycarbonate diol. Herein, “liquid polycarbonate diol” means the polycarbonate diol is a viscous liquid at a temperature of 25° C. If the liquid polycarbonate diol is used, the paint film is softer and thus the shot feeling of the golf ball hit with a putter is better. The viscosity of the liquid polycarbonate diol preferably ranges from 50 mPa·s/50° C. to 100,000 mPa·s/50° C., ranges from 30 mPa·s/60° C. to 50,000 mPa·s/60° C., or ranges from 10 mPa·s/70° C. to 20,000 mPa·s/70° C. The viscosity can be measured, for example, with a B type viscometer and a rotor HM2.

The viscosity of the liquid polycarbonate diol is preferably 50 mPa·s/50° C. or more and 100,000 mPa·s/50° C. or less, more preferably 100 mPa·s/50° C. or more and 5,000 mPa·s/50° C. or less, and even more preferably 200 mPa·s/50° C. or more and 2,000 mPa·s/50° C. or less.

The number average molecular weight of the polycarbonate diol is preferably 400 or more, more preferably 450 or more, and even more preferably 500 or more, and is preferably 1200 or less, more preferably 1100 or less, and even more preferably 1000 or less. If the number average molecular weight of the polycarbonate diol is 400 or more and 1,200 or less, the distance between the crosslinking points in the paint film is appropriate, and thus the shot feeling of the golf ball hit with a putter is better. It is noted that the number average molecular weight of the polyol can be measured, for example, by gel permeation chromatography (GPC), using polystyrene as a standard material, tetrahydrofuran as an eluate, and an organic solvent system GPC column (e.g. “Shodex (registered trademark) KF series” available from Showa Denko K.K.) as a column.

Examples of the polyisocyanate component constituting the polyurethane comprised in the golf ball paint resin according to the present disclosure include a compound having at least two isocyanate groups. Examples of the polyisocyanate include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and para-phenylene diisocyanate (PPDI); an alicyclic polyisocyanate or aliphatic polyisocyanate such as 4,4′-dicyclohexylmethane diisocyanate (H₁₂MDI), hydrogenated xylylene diisocyanate (H₆XDI), hexamethylene diisocyanate (HDI), isophorone diisocyanate (IPDI), and norbornene diisocyanate (NBDI); and derivatives of these polyisocyanates. In the present disclosure, two or more of the polyisocyanates may be used in combination.

Examples of the derivatives of the polyisocyanate include an adduct-modified product obtained by a reaction between a diisocyanate and a polyhydric alcohol; an isocyanurate-modified product of a diisocyanate; a biuret-modified product; and an allophanate product, and the one from which free diisocyanate has been removed is more preferable. The polyisocyanate composition preferably contains, as a polyisocyanate component, at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

The biuret-modified product is, for example, a biuret-modified product in which a diisocyanate is trimerized (the following formula (1)). In the formula (1), R represents a residue where isocyanate groups are removed from the diisocyanate. The biuret-modified product is preferably a trimer of hexamethylene diisocyanate.

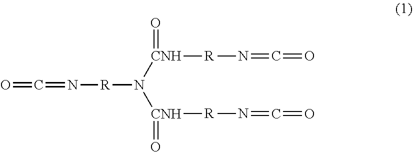

Examples of the isocyanurate-modified product include a trimer of diisocyanate represented by the following formula (2). In the formula (2), R represents a residue where isocyanate groups are removed from the diisocyanate. Examples of the isocyanurate-modified product include an isocyanurate-modified product of hexamethylene diisocyanate and an isocyanurate-modified product of isophorone diisocyanate, and a trimer of hexamethylene diisocyanate or a trimer of the isocyanurate-modified product of isophorone diisocyanate is preferable.

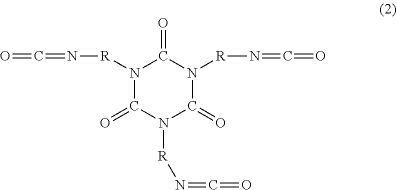

The adduct-modified product is a polyisocyanate obtained by a reaction between a diisocyanate and a polyhydric alcohol. The polyhydric alcohol is preferably a low molecular weight triol such as trimethylolpropane or glycerin. The adduct-modified product is preferably, for example, a triisocyanate (the following formula (3)) obtained by a reaction between a diisocyanate and trimethylolpropane, and a triisocyanate (the following formula (4)) obtained by a reaction between a diisocyanate and glycerin. In the formulae (3) and (4), R represents a residue where isocyanate groups are removed from the diisocyanate.

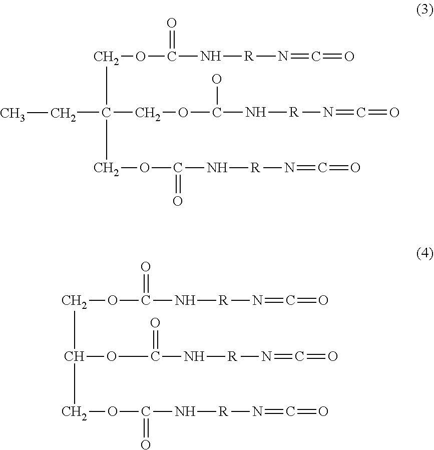

The adduct-modified product is preferably, for example, an adduct-modified product of hexamethylene diisocyanate, more preferably a triisocyanate obtained by a reaction between hexamethylene diisocyanate and trimethylolpropane, and a triisocyanate obtained by a reaction between hexamethylene diisocyanate and glycerin.

The allophanate product is, for example, a triisocyanate obtained by further reacting a diisocyanate with a urethane bond formed by a reaction between a diisocyanate and a low molecular weight diol.

### Adduct-Modified Product

In a preferable embodiment of the present disclosure, the polyisocyanate component is preferably the adduct-modified product, more preferably the adduct-modified product of hexamethylene diisocyanate (preferably a trimer). In the case that the adduct-modified product of hexamethylene diisocyanate is used, the amount of the adduct-modified product of hexamethylene diisocyanate in the polyisocyanate component is preferably 10 mass % or more, more preferably 20 mass % or more, and even more preferably 30 mass % or more. The polyisocyanate component may consist of the adduct-modified product of hexamethylene diisocyanate.

### Isocyanurate-Modified Product

In another preferable embodiment of the present disclosure, the polyisocyanate component is preferably the isocyanurate-modified product, more preferably the isocyanurate-modified product of hexamethylene diisocyanate (preferably a trimer) or the isocyanurate-modified product of isophorone diisocyanate (preferably a trimer). The isocyanurate-modified product of hexamethylene diisocyanate (preferably a trimer) and the isocyanurate-modified product of isophorone diisocyanate (preferably a trimer) may be used in combination. In the case that the isocyanurate-modified product of hexamethylene diisocyanate and the isocyanurate-modified product of isophorone diisocyanate are used in combination, the mass ratio (isocyanurate-modified product of hexamethylene diisocyanate/isocyanurate-modified product of isophorone diisocyanate) of the isocyanurate-modified product of hexamethylene diisocyanate to the isocyanurate-modified product of isophorone diisocyanate is preferably 0.1 or more, more preferably 0.2 or more, and even more preferably 0.3 or more, and is preferably 9 or less, more preferably 4 or less, and even more preferably 3 or less.

### Adduct-Modified Product+Isocyanurate-Modified Product

In another preferable embodiment of the present disclosure, the polyisocyanate component is preferably a combination of the adduct-modified product and the isocyanurate-modified product, more preferably a combination of the adduct-modified product of hexamethylene diisocyanate (preferably a trimer) and the isocyanurate-modified product of hexamethylene diisocyanate (preferably a trimer), or a combination of the adduct-modified product of hexamethylene diisocyanate (preferably a trimer) and the isocyanurate-modified product of isophorone diisocyanate (preferably a trimer). In this case, the mass ratio (adduct-modified product/isocyanurate-modified product) of the adduct-modified product to the isocyanurate-modified product is preferably 0.1 or more, more preferably 0.3 or more, and even more preferably 0.4 or more, and is preferably 9 or less, more preferably 5 or less, and even more preferably 4 or less.

### HDI Adduct-Modified Product+HDI Isocyanurate-Modified Product

In another preferable embodiment of the present disclosure, when the adduct-modified product of hexamethylene diisocyanate and the isocyanurate-modified product of hexamethylene diisocyanate are used as the polyisocyanate component, the total amount of the adduct-modified product of hexamethylene diisocyanate and the isocyanurate-modified product of hexamethylene diisocyanate in the polyisocyanate component is preferably 70 mass % or more, more preferably 80 mass % or more, and even more preferably 90 mass % or more. It is also preferable that the polyisocyanate component consists of the adduct-modified product of hexamethylene diisocyanate and the isocyanurate-modified product of hexamethylene diisocyanate.

### HDI Isocyanurate-Modified Product+IPDI Isocyanurate-Modified Product

In another preferable embodiment of the present disclosure, when the isocyanurate-modified product of hexamethylene diisocyanate and the isocyanurate-modified product of isophorone diisocyanate are used as the polyisocyanate component, the total amount of the isocyanurate-modified product of hexamethylene diisocyanate and the isocyanurate-modified product of isophorone diisocyanate in the polyisocyanate component is preferably 70 mass % or more, more preferably 80 mass % or more, and even more preferably 90 mass % or more. It is also preferable that the polyisocyanate component consists of the isocyanurate-modified product of hexamethylene diisocyanate and the isocyanurate-modified product of isophorone diisocyanate.

### HDI Adduct-Modified Product+IPDI Isocyanurate-Modified Product

In another preferable embodiment of the present disclosure, when the adduct-modified product of hexamethylene diisocyanate and the isocyanurate-modified product of isophorone diisocyanate are used as the polyisocyanate component, the total amount of the adduct-modified product of hexamethylene diisocyanate and the isocyanurate-modified product of isophorone diisocyanate in the polyisocyanate component is preferably 70 mass % or more, more preferably 80 mass % or more, and even more preferably 90 mass % or more. It is also preferable that the polyisocyanate component consists of the adduct-modified product of hexamethylene diisocyanate and the isocyanurate-modified product of isophorone diisocyanate.

The amount of the isocyanate group (NCO %) included in the polyisocyanate component is preferably 0.5 mass % or more, more preferably 1.0 mass % or more, and even more preferably 2.0 mass % or more, and is preferably 45 mass % or less, more preferably 40 mass % or less, and even more preferably 35 mass % or less. It is noted that the amount of the isocyanate group (NCO %) included in the polyisocyanate component can be represented by the following expression.

$$N C O ( \% ) = 100 \times [ mole number of the isocyanate group included in the polyisocyanate \times 42 ( molecular weight of N C O ) ] \text{} / [ \text{} total mass ( g ) of the polyisocyanate ]$$

Specific examples of the polyisocyanate component include Burnock (registered trademark) D-800, Burnock DN-950, and Burnock DN-955 available from DIC corporation; Desmodur (registered trademark) N75MPA/X, Desmodur N3300, Desmodur N3390, Desmodur L75 (C), and Sumidur (registered trademark) E21-1 available from Sumika Covestro Urethane Company, Ltd.; Coronate (registered trademark) HX, Coronate HK, Coronate HL, and Coronate EH available from Tosoh Corporation; Duranate (registered trademark) 24A-100, Duranate 21S-75E, Duranate TPA-100, Durante TKA-100, Durante 24A-90CX, and Durante E402-80B available from Asahi Kasei Chemicals Corporation; and VESTANAT (registered trademark) T1890 available from Degussa.

The paint resin of the golf ball according to the present disclosure is preferably formed from a paint comprising a polyol composition containing a polyol component and a polyisocyanate composition containing a polyisocyanate component. Examples of the paint include a so-called curing type paint having the polyol composition as a base material and the polyisocyanate composition as a curing agent. Next, the materials for forming the polyurethane used in the present disclosure will be explained.

### Polyol Composition

The polyol composition used in the present disclosure preferably contains a urethane polyol as the polyol component. The urethane polyol is a compound having a plurality of urethane bonds in the molecule and having at least two hydroxyl groups in one molecule. Examples of the urethane polyol include a urethane prepolymer obtained by a reaction between a first polyol component and a first polyisocyanate component under a condition that the amount of hydroxyl groups in the first polyol component is excessive to the amount of isocyanate groups in the first polyisocyanate component.

It is preferable that the polyol composition used in the present disclosure contains the urethane polyol as the polyol component, and the urethane polyol includes the polycarbonate diol as the first polyol component. As the polycarbonate diol, those listed as the polycarbonate diol component constituting the polyurethane can be preferably used.

It is also preferable that the urethane polyol includes, as the first polyol component, a component derived from a low molecular weight polyol having a molecular weight of less than 400 or a high molecular weight polyol having a number average molecular weight of 400 or more, in addition to the polycarbonate diol.

Examples of the low molecular weight polyol include a diol such as ethylene glycol, diethylene glycol, triethylene glycol, 1,3-butanediol, 1,4-butanediol, neopentyl glycol, and 1,6-hexanediol; and a triol such as glycerin, trimethylolpropane, and hexanetriol. The low molecular weight polyol may be used solely or as a mixture of at least two of them.

Examples of the high molecular weight polyol include a polyether polyol, a polyester polyol, a polycaprolactone polyol, and an acrylic polyol. Examples of the polyether polyol include polyoxyethylene glycol (PEG), polyoxypropylene glycol (PPG), and polyoxytetramethylene glycol (PTMG). Examples of the polyester polyol include polyethylene adipate (PEA), polybutylene adipate (PBA), and polyhexamethylene adipate (PHMA). Examples of the polycaprolactone polyol include poly-E-caprolactone (PCL). The high molecular weight polyol may be used solely or as a mixture of at least two of them.

The amount of the polycarbonate diol in the urethane polyol is preferably 20 mass % or more, more preferably 30 mass % or more, and even more preferably 40 mass % or more. In addition, the amount of the polycarbonate diol in the urethane polyol is preferably 90 mass % or less, more preferably 85 mass % or less, and even more preferably 80 mass % or less. It is noted that the amount of the polycarbonate diol in the urethane polyol can be calculated based on the mixing ratio of the first polyol component to the first polyisocyanate component for forming the urethane polyol.

The urethane polyol preferably includes the triol component and the diol component as the first polyol component. As the triol component, trimethylolpropane is preferable. The mixing ratio of the triol component to the diol component (triol component/diol component) is preferably 1.0 or more, more preferably 1.2 or more, and is preferably 2.6 or less, more preferably 2.4 or less in a molar ratio.

The first polyisocyanate component constituting the urethane polyol is not particularly limited, as long as the first polyisocyanate component has at least two isocyanate groups. Examples of the first polyisocyanate component include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylenediisocyanate (TMXDI), and para-phenylene diisocyanate (PPDI); and an alicyclic polyisocyanate or aliphatic polyisocyanate such as 4,4′-dicyclohexylmethane diisocyanate (H₁₂MDI), hydrogenated xylylenediisocyanate (H₆XDI), hexamethylene diisocyanate (HDI), isophorone diisocyanate (IPDI), and norbornene diisocyanate (NBDI). These polyisocyanates may be used solely or as a mixture of at least two of them.

The urethane polyol preferably includes the alicyclic diisocyanate as the first polyisocyanate component.

The weight average molecular weight of the urethane polyol is preferably 5,000 or more, more preferably 5,300 or more, and even more preferably 5,500 or more, and is preferably 20,000 or less, more preferably 18,000 or less, and even more preferably 16,000 or less. If the weight average molecular weight of the urethane polyol is 5,000 or more and 20,000 or less, the shot feeling of the golf ball hit with a putter is better.

The hydroxyl value of the urethane polyol is preferably 10 mgKOH/g or more, more preferably 15 mgKOH/g or more, and even more preferably 20 mgKOH/g or more, and is preferably 200 mgKOH/g or less, more preferably 190 mgKOH/g or less, and even more preferably 180 mgKOH/g or less. It is noted that the hydroxyl value can be measured according to JIS K 1557-1, for example, by an acetylation method.

In a preferable embodiment according to the present disclosure, the polyol component of the polyol composition used in the present disclosure consists of the urethane polyol.

The amount of the urethane polyol in the polyol component contained in the polyol composition is preferably 50 mass % or more, more preferably 80 mass % or more, and even more preferably 90 mass % or more. The polyol component contained in the polyol composition also preferably consists of the urethane polyol.

### Polyisocyanate Composition

Examples of the polyisocyanate component of the polyisocyanate composition used in the present disclosure include those listed as the polyisocyanate constituting the polyurethane. Examples of the polyisocyanate include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylenediisocyanate (TMXDI), and para-phenylene diisocyanate (PPDI); an alicyclic polyisocyanate or aliphatic polyisocyanate such as 4,4′-dicyclohexylmethane diisocyanate (H₁₂MDI), hydrogenated xylylenediisocyanate (H₆XDI), hexamethylene diisocyanate (HDI), isophorone diisocyanate (IPDI), and norbornene diisocyanate (NBDI); and derivatives of these polyisocyanates. The polyisocyanate composition used in the present disclosure preferably contains the hexamethylene diisocyanate as the polyisocyanate. In the present disclosure, at least two polyisocyanates may be used as the polyisocyanate.

Examples of the derivatives of the polyisocyanate include an adduct-modified product obtained by a reaction between a diisocyanate and a polyhydric alcohol; an isocyanurate-modified product of a diisocyanate; a biuret-modified product; and an allophanate-modified product. The derivative of the polyisocyanate from which free diisocyanate is removed is more preferable. The polyisocyanate composition preferably contains, as the polyisocyanate component, at least one member selected from the group consisting of an isocyanurate-modified product of hexamethylene diisocyanate, an adduct-modified product of hexamethylene diisocyanate, a biuret-modified product of hexamethylene diisocyanate, and an isocyanurate-modified product of isophorone diisocyanate.

In the curing reaction of the curing type paint composition, the molar ratio (NCO group/OH group) of the isocyanate group (NCO group) included in the polyisocyanate composition to the hydroxyl group (OH group) included in the polyol composition is preferably 0.6 or more, more preferably 0.75 or more, and even more preferably 0.9 or more. If the molar ratio (NCO group/OH group) is 0.6 or more, the curing reaction is sufficient. The molar ratio (NCO group/OH group) is preferably 1.4 or less, more preferably 1.3 or less, and even more preferably 1.2 or less. If the molar ratio (NCO group/OH group) is 1.4 or less, the amount of the isocyanate group is not excessive, and the obtained paint film has more appropriate hardness and better appearance. It is noted that the reason why the appearance of the obtained paint film deteriorates if the amount of the isocyanate group is excessive in the paint is considered that an excessive amount of the isocyanate group may promote a reaction between the moisture in the air and the isocyanate group, thereby generating a lot of carbon dioxide gas.

The paint may be either a waterborne paint mainly containing water as a dispersion medium or a solvent-based paint containing an organic solvent as a dispersion medium, and the solvent-based paint is preferable. In case of the solvent-based paint, preferable examples of the solvent include toluene, isopropyl alcohol, xylene, methyl ethyl ketone, methyl ethyl isobutyl ketone, ethylene glycol monomethyl ether, ethylbenzene, propylene glycol monomethyl ether, isobutyl alcohol, and ethyl acetate. It is noted that the solvent may be blended in either the polyol composition or the polyisocyanate composition. From the viewpoint of uniformly performing the curing reaction, the solvent is preferably blended in each of the polyol composition and the polyisocyanate composition.

A conventionally known catalyst can be employed in the curing reaction. Examples of the catalyst include a monoamine such as triethyl amine and N,N-dimethylcyclohexylamine; a polyamine such as N,N,N′,N′-tetramethylethylene diamine and N, N,N′,N″,N″-pentamethyldiethylene triamine; a cyclic diamine such as 1,8-diazabicyclo[5.4.0]-7-undecene (DBU) and triethylene diamine; a tin catalyst such as dibutyl tin dilaurate and dibutyl tin diacetate. These catalysts may be used solely, or two or more of the catalysts may be used in combination. Among them, the tin catalyst such as dibutyl tin dilaurate and dibutyl tin diacetate is preferable, dibutyl tin dilaurate is particularly preferable.

The paint may further include additives that can be generally included in a paint for a golf ball, such as an ultraviolet absorber, an antioxidant, a light stabilizer, a fluorescent brightener, an anti-blocking agent, a leveling agent, a slip agent, and a viscosity modifier, where necessary.

The golf ball according to the present disclosure is a golf ball comprising a golf ball body and a paint film composed of at least one layer and formed on a surface of the golf ball body, wherein an outermost layer of the paint film is at least formed from the golf ball paint resin according to the present disclosure.

When the paint film has a multiple layered structure, the layer positioned on the outermost side of the paint film is the outermost layer of the paint film. When the paint film has a single layered structure, the single layered paint film is the outermost layer of the paint film.

When the paint film has a multiple layered structure, examples of the base resin constituting the paint film layer other than the outermost paint film layer include a polyurethane, an epoxy resin, an acrylic resin, a vinyl acetate resin, and a polyester resin, and among them, the polyurethane is preferable. In addition, as the base resin constituting the paint film layer other than the outermost paint film layer, the polyurethane used in the above-described outermost paint film layer may be used.

The thickness of the paint film formed from the golf ball paint resin according to the present disclosure is preferably 5 μm or more, more preferably 7 μm or more, and even more preferably 9 μm or more, and is preferably 40 μm or less, more preferably 30 μm or less, and even more preferably 20 μm or less. If the thickness of the paint film falls within the above range, the appearance is better.

When the golf ball according to the present disclosure has a multiple layered paint film, the total thickness of the whole paint film is preferably 5 μm or more, more preferably 7 μm or more, and even more preferably 9 μm or more, and is preferably 50 μm or less, more preferably 45 μm or less, and even more preferably 40 μm or less. If the thickness film falls within the above range, the appearance is better.

### Golf Ball

The golf ball according to the present disclosure is not particularly limited, as long as it comprises a golf ball body and a paint film composed of at least one layer and formed on a surface of the golf ball body. The construction of the golf ball body is not particularly limited, and may be a one-piece golf ball, a two-piece golf ball, or a multi-piece golf ball composed of three or more pieces. The present disclosure can be applied appropriately to any one of the above golf ball bodies.

### Core

A one-piece golf ball body, and a core used in a two-piece golf ball and a multi-piece golf ball will be explained.

The one-piece golf ball body and core can be formed from a conventional rubber composition (hereinafter sometimes simply referred to as “core rubber composition”). For example, the one-piece golf ball body and core can be molded by heat pressing a rubber composition containing a base rubber, a co-crosslinking agent and a crosslinking initiator.

As the base rubber, particularly preferred is a high-cis polybutadiene having a cis bond in an amount of 40 mass % or more, preferably 70 mass % or more, and more preferably 90 mass % or more in view of its superior resilience. As the co-crosslinking agent, an α,β-unsaturated carboxylic acid having 3 to 8 carbon atoms or a metal salt thereof is preferable, and a metal salt of acrylic acid or a metal salt of methacrylic acid is more preferable. As the metal constituting the metal salt, zinc, magnesium, calcium, aluminum or sodium is preferable, and zinc is more preferable. The amount of the co-crosslinking agent is preferably 20 parts by mass or more and 50 parts by mass or less with respect to 100 parts by mass of the base rubber. In a case that the α,β-unsaturated carboxylic acid having 3 to 8 carbon atoms is used as the co-crosslinking agent, a metal compound (e.g. magnesium oxide) is preferably added. As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di (t-butylperoxy) hexane, and di-t-butyl peroxide. Among them, dicumyl peroxide is preferably used. The amount of the crosslinking initiator is preferably 0.2 part by mass or more, more preferably 0.3 part by mass or more, and is preferably 3 parts by mass or less, more preferably 2 parts by mass or less, with respect to 100 parts by mass of the base rubber.

In addition, the core rubber composition may further contain an organic sulfur compound. As the organic sulfur compound, a compound which belongs to diphenyl disulfides (e.g. diphenyl disulfide, bis(pentabromophenyl) disulfide), thiophenols or thionaphthols (e.g. 2-thionaphthol) is preferably used. The amount of the organic sulfur compound is preferably 0.1 part by mass or more, more preferably 0.3 part by mass or more, and is preferably 5.0 parts by mass or less, more preferably 3.0 parts by mass or less, with respect to 100 parts by mass of the base rubber. The core rubber composition may further contain a carboxylic acid and/or a salt thereof. As the carboxylic acid and/or the salt thereof, a carboxylic acid having 1 to 30 carbon atoms and/or a salt thereof is preferable. As the carboxylic acid, any one of an aliphatic carboxylic acid and an aromatic carboxylic acid (such as benzoic acid) may be used. The amount of the carboxylic acid and/or the salt thereof is preferably 1 part by mass or more and 40 parts by mass or less with respect to 100 parts by mass of the base rubber.

The core rubber composition may further contain a weight adjusting agent such as zinc oxide and barium sulfate, an antioxidant, a colored powder, or the like in addition to the base rubber, the co-crosslinking agent, the crosslinking initiator, and the organic sulfur compound. The molding conditions for heat pressing the core rubber composition may be determined appropriately depending on the rubber composition. Generally, the heat pressing is preferably carried out at a temperature in a range from 130° C. to 200° C. for 10 to 60 minutes, or carried out in a two-step heating of heating at a temperature in a range from 130° C. to 150° C. for 20 to 40 minutes followed by heating at a temperature in a range from 160° C. to 180° C. for 5 to 15 minutes.

### Cover

The golf ball body preferably comprises the core and a cover covering the core. The material hardness of the cover composition constituting the cover is preferably set in accordance with the desired performance of the golf ball. For example, in case of a so-called distance golf ball which focuses on a flight distance, the material hardness of the cover composition is preferably 45 or more, more preferably 50 or more, and even more preferably 55 or more, and is preferably 80 or less, more preferably 75 or less, and even more preferably 70 or less in shore D hardness. If the material hardness of the cover composition is 45 or more in Shore D hardness, the obtained golf ball has a higher launch angle and a lower spin rate on driver shots and iron shots, and thus travels a greater distance. In addition, if the material hardness of the cover composition is 80 or less in Shore D hardness, the obtained golf ball has better durability. Further, in case of a so-called spin golf ball which focuses on controllability, the material hardness of the cover composition is preferably less than 50, and is preferably 20 or more, more preferably 23 or more, and even more preferably 26 or more in shore D hardness. If the material hardness of the cover composition is less than 50 in Shore D hardness, the obtained golf ball has a greater spin rate on iron shots and is easily controlled. In addition, if the material hardness of the cover composition is 20 or more in Shore D hardness, the durability is enhanced. It is noted that the material hardness of the cover is a slab hardness of the cover composition for forming the cover molded into a sheet shape.

The thickness of the cover is preferably 4.0 mm or less, more preferably 3.0 mm or less, and even more preferably 2.0 mm or less. If the thickness of the cover is 4.0 mm or less, the obtained golf ball has better resilience or shot feeling. The thickness of the cover is preferably 0.3 mm or more, more preferably 0.4 mm or more, and even more preferably 0.5 mm or more. If the thickness of the cover is 0.3 mm or more, the cover has better durability.

The resin component constituting the cover is not particularly limited, and examples thereof include various resins such as an ionomer resin, a polyester resin, a urethane resin and a polyamide resin; a thermoplastic polyamide elastomer having a trade name of “Pebax (registered trademark) (e.g. “Pebax 2533”)” available from Arkema Inc.; a thermoplastic polyester elastomer having a trade name of “Hytrel (registered trademark) (e.g. “Hytrel 3548” and “Hytrel 4047”)” available from Du Pont-Toray Co., Ltd.; a thermoplastic polyurethane elastomer having a trade name of “Elastollan (registered trademark) (e.g. “Elastollan XNY82A” and “Elastollan XNY97A”)” available from BASF Japan Ltd.; and a thermoplastic styrene elastomer having a trade name of “TEFABLOC” or thermoplastic polyester elastomer available from Mitsubishi Chemical Corporation. These cover materials may be used solely, or two or more of these cover materials may be used in combination.

Among them, the resin component constituting the cover is preferably the polyurethane or the ionomer resin, particularly preferably the polyurethane. When the resin component constituting the cover includes the polyurethane, the amount of the polyurethane in the resin component is preferably 50 mass % or more, more preferably 70 mass % or more, and even more preferably 90 mass % or more. When the resin component constituting the cover includes the ionomer resin, the amount of the ionomer resin in the resin component is preferably 50 mass % or more, more preferably 70 mass % or more, and even more preferably 90 mass % or more.

The polyurethane may be either a thermoplastic polyurethane or a thermosetting polyurethane. The thermoplastic polyurethane is a polyurethane exhibiting plasticity by heating and generally means a polyurethane having a linear chain structure of a high molecular weight to a certain extent. On the other hand, thermosetting polyurethane (two-component curing type polyurethane) is a polyurethane obtained by polymerization through a reaction between a low molecular weight urethane prepolymer and a curing agent (chain extender) when molding the cover. The thermosetting polyurethane includes a polyurethane having a linear chain structure, or a polyurethane having a three-dimensional crosslinked structure depending on the number of the functional group of the prepolymer or curing agent (chain extender) to be used. The polyurethane is preferably thermoplastic elastomer.

The cover may contain a pigment component such as a white pigment (e.g. titanium oxide), a blue pigment and a red pigment, a weight adjusting agent such as calcium carbonate and barium sulfate, a dispersant, an antioxidant, an ultraviolet absorber, a light stabilizer, a fluorescent material or fluorescent brightener, or the like, in addition to the above resin component, as long as they do not impair the performance of the cover.

The embodiment for molding the cover from the cover composition is not particularly limited, and examples thereof include an embodiment comprising injection molding the cover composition directly onto the core; and an embodiment comprising molding the cover composition into hollow shells, covering the core with a plurality of the hollow shells and compression molding the core with a plurality of the hollow shells (preferably an embodiment comprising molding the cover composition into half hollow-shells, covering the core with two of the half hollow-shells and compression molding the core with two of the half hollow-shells). After the cover is molded, the obtained golf ball body is ejected from the mold, and as necessary, the golf ball body is preferably subjected to surface treatments such as deburring, cleaning, and sandblast. If desired, a mark may be formed.

The total number of dimples formed on the cover is preferably 200 or more and 500 or less. If the total number is less than 200, the dimple effect is hardly obtained. On the other hand, if the total number exceeds 500, the dimple effect is hardly obtained because the size of the respective dimples is small. The shape (shape in a plan view) of dimples includes, for example, without limitation, a circle, a polygonal shape such as a roughly triangular shape, a roughly quadrangular shapes, a roughly pentagonal shape, a roughly hexagonal shape, and other irregular shape. The shape of dimples is employed solely or at least two of them may be used in combination.

In the case that the golf ball is a three-piece golf ball, a four-piece golf ball, or a multi-piece golf ball comprising five or more pieces, an intermediate layer is disposed between the core and the outmost cover. Examples of the material constituting the intermediate layer include a thermoplastic resin such as a polyurethane, an ionomer resin, a polyamide, and a polyethylene; a thermoplastic elastomer such as a styrene elastomer, a polyolefin elastomer, a polyurethane elastomer, and a polyester elastomer; and a cured product of a rubber composition. Herein, examples of the ionomer resin include a product obtained by neutralizing, with a metal ion, at least a part of carboxyl groups in a copolymer composed of ethylene and an α,β-unsaturated carboxylic acid; and a product obtained by neutralizing, with a metal ion, at least a part of carboxyl groups in a terpolymer composed of ethylene, an α,β-unsaturated carboxylic acid and an α,β-unsaturated carboxylic acid ester. The intermediate layer may further contain a weight adjusting agent such as barium sulfate and tungsten, an antioxidant, and a pigment. It is noted that the intermediate layer may be referred to as an inner cover layer or an outer core depending on the construction of the golf ball.

### Formation of Paint Film

The paint film of the golf ball according to the present disclosure can be formed by applying the paint on the surface of the golf ball body. The method of applying the paint is not particularly limited, a conventional method can be adopted, and examples thereof include a spray coating and electrostatic coating.

In the case of performing the spray coating with an air gun, the polyisocyanate composition and the polyol composition are fed with respective pumps and continuously mixed with a line mixer located in the stream line just before the air gun, and the obtained mixture is air-sprayed. Alternatively, the polyisocyanate composition and the polyol composition are air-sprayed respectively with an air spray system provided with a device for controlling the mixing ratio thereof. The paint application may be conducted by spraying the paint one time or overspraying the paint multiple times.

The paint applied on the golf ball body can be dried, for example, at a temperature in a range of from 30° C. to 70° C. for 1 hour to 24 hours, to form the paint film.

The golf ball according to the present disclosure preferably has a diameter in a range from 40 mm to 45 mm. In light of satisfying the regulation of US Golf Association (USGA), the diameter is particularly preferably 42.67 mm or more. In light of prevention of air resistance, the diameter is more preferably 44 mm or less, even more preferably 42.80 mm or less. In addition, the golf ball according to the present disclosure preferably has a mass of 40 g or more and 50 g or less. In light of obtaining greater inertia, the mass is more preferably 44.00 g or more, even more preferably 45.00 g or more. In light of satisfying the regulation of USGA, the mass is particularly preferably 45.93 g or less.

When the golf ball according to the present disclosure has a diameter in a range from 40 mm to 45 mm, the compression deformation amount (shrinking amount along the compression direction) of the golf ball when applying a load from 98 N as an initial load to 1275 N as a final load to the golf ball is preferably 2.0 mm or more, more preferably 2.1 mm or more, and even more preferably 2.2 mm or more, and is preferably 4.0 mm or less, more preferably 3.5 mm or less, and even more preferably 3.0 mm or less. If the compression deformation amount is 2.0 mm or more, the golf ball is not excessively hard and thus the shot feeling thereof is better. On the other hand, if the compression deformation amount is 4.0 mm or less, the resilience is greater.

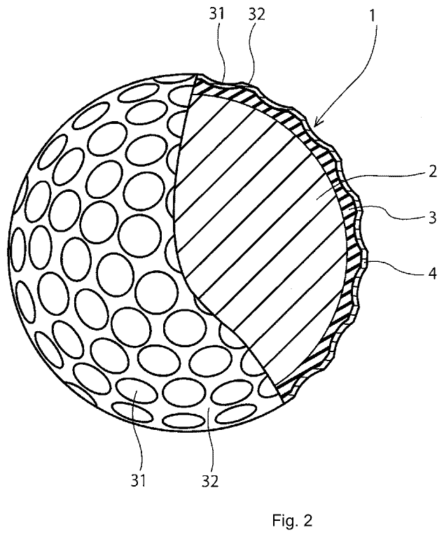

FIG. 2 is a partially cutaway cross-sectional view of a golf ball 1 according to one embodiment of the present disclosure. The golf ball 1 comprises a spherical core 2, a cover 3 covering the spherical core 2, and a paint film 4 formed on a surface of the cover 3. A plurality of dimples 31 are formed on the surface of the cover 3. Other portions than the dimples 31 on the surface of the cover 3 are lands 32.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### Evaluation Method

### (1) Slab Hardness (Shore D Hardness)

Sheets with a thickness of about 2 mm were produced by injection molding the intermediate layer composition or cover composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II available from Bareiss company) using a detector of “Shore D”.

### (2) Thickness of Paint Film (μm)

The golf ball was cut into two hemispheres, and the cross section of the paint film on the hemisphere was observed with a microscope (VHX-1000 available from Keyence Corporation) to obtain the thickness of the paint film.

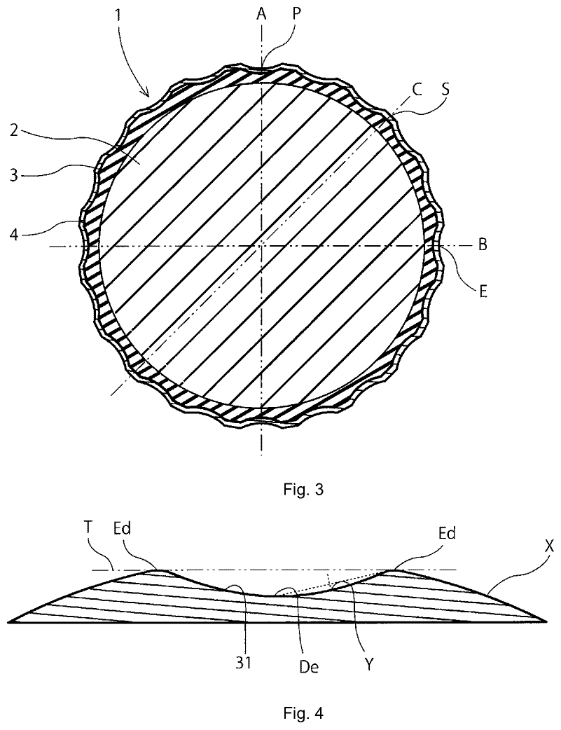

The measuring location of the film thickness will be explained by reference to FIGS. 3 and 4. FIG. 3 is a schematic figure of a cross section of a golf ball. As shown in FIG. 3, on the cross section of the golf ball, a straight line A is drawn to pass a central point of the ball and a bottom of any dimple, a straight line B perpendicular to the straight line A is drawn to pass the central point of the golf ball, and a straight line C is drawn to have an angle of 45° to the straight line A on the A-B plane, and intersection points of these straight lines with the paint film surface are adopted as a pole P, an equator E and a shoulder S, respectively.

FIG. 4 is a schematic figure of a cross section passing a bottom De of a dimple 31 and a central point of a golf ball 1. The bottom De of the dimple 31 is the deepest location of the dimple 31. An edge Ed is a point of tangency of the dimple 31 with a tangent T, wherein the tangent T is drawn by connecting both sides of the dimple 31. A measuring location Y on an inclined plane is a point at which a perpendicular line intersects with the inclined plane of the dimple, wherein the perpendicular line is drawn from a midpoint of a straight line connecting the bottom

De of the dimple and the edge Ed downward to the dimple 31. A measuring location X on a land is a midpoint between edges of adjacent dimples. It is noted that in the case that adjacent dimples contact each other so that no land exists, or in the case that the land is so narrow that the thickness is hard to be measured, the bottom, edge or inclined plane of the dimple is adopted as the measuring point.

In the measurement, test samples were firstly prepared from three locations of six balls, i.e. the dimple where the pole P exists, the dimple near the equator E and the dimple near the shoulder S. Next, regarding each test piece (dimple), the thickness of the paint film at the bottom De, edge Ed, inclined plane Y and land X of the dimple was measured. Finally, measuring values of six balls were averaged, and the obtained average value was adopted as the thickness of the paint film.

### (3) Tensile Test

A paint obtained by blending the polyisocyanate composition and the polyol composition was dried and cured at a temperature of 40° C. for 4 hours to prepare a paint film (thickness: 100 μm±10 μm).

The paint film was cut into a shape with a width of 4 mm and a length of 30 mm to prepare a test piece. The tensile test was conducted with a dynamic viscoelasticity measuring apparatus (Rheogel-E4000 available from UBM CO., Ltd.) under the following test conditions.

### Test Conditions

distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%)

### (4) Spin Rate on Approach Shots From the Rough (Under a Condition That There is Grass Between the Golf Ball and the Club Face)

A sand wedge (trade name: “CG 15 forged wedge”, loft angel: 58°, available from Cleveland Golf Inc.) was installed on a swing machine available from Golf Laboratories, Inc. The golf ball was hit at a head speed of 16 m/s, and the spin rate (rpm) thereof was measured by continuously taking a sequence of photographs of the hit golf ball. It is noted that two leaves (length: about 3 cm) of wild grass were attached to the golf ball that was the testing object, and the golf ball was hit such that there was the wild grass between the club face and the golf ball. The measurement was conducted ten times for each golf ball, and the average value thereof was adopted as the spin rate.

### (5) Wear Resistance

In a ball mill having a volume of 7 liters, 2500 g of grinding stone (“AT3” available from Tipton Corporation) and 2500 ml of water were filled. In this ball mill, 40 golf balls were charged. The ball mill was rotated at a rotation speed of 50 rpm for 1 hour, and the appearance of the golf balls after the ball milling was visually checked and evaluated as follows.

E (excellent): Number of the balls where the paint film has a peeling spot whose area is same to or larger than one dimple, is less than 5.

G (good): Number of the balls where the paint film has a peeling spot whose area is same to or larger than one dimple, is 5 or more and less than 10.

F (fair): Number of the balls where the paint film has a peeling spot whose area is same to or larger than one dimple, is 10 or more and less than 20.

P (poor): Number of the balls where the paint film has a peeling spot whose area is same to or larger than one dimple, is 20 or more.

### (6) Stain Resistance

A sand wedge (trade name: “CG 15 forged wedge”, loft angel: 58°, available from Cleveland Golf Inc.) was installed on a swing machine available from Golf Laboratories, Inc. The golf ball set in the bunker was hit at a head speed of 16 m/s. Each golf ball was hit ten times. The golf ball after the hitting was visually observed by 20 golfer players. The number of the players who answered that he or she was conscious of stain was accounted, and the stain resistance was evaluated according to the following standard.
E (excellent): 5 persons or less
G (Good): 6 persons or more and 10 persons or less
F (Fair): 11 persons or more and 15 persons or less
P (Poor): 16 persons or more

### Production of Golf Ball

### 1. Production of Spherical Core

According to the formulation shown in Table 1, the rubber composition was kneaded, and heat-pressed at a temperature of 150° C. for 19 min in upper and lower molds, each having a hemispherical cavity, to obtain a spherical core having a diameter of 39.7 mm. It is noted that the amount of barium sulfate was adjusted such that the ball had a mass of 45.6 g.

TABLE 1
Core composition

| | | |
|---|---|---|
| Formulation | Polybutadiene | 100 |
| (parts by mass) | Zinc acrylate | 35 |
| | Zinc oxide | 5 |
| | Barium sulfate | Appropriate amount |
| | Diphenyl disulfide | 0.5 |
| | Dicumyl peroxide | 0.9 |

Polybutadiene rubber: “BR730 (high-cis polybutadiene)” available from JSR Corporation
Zinc acrylate: “ZN-DA90S” available from Nisshoku Techno Fine Chemical Co., Ltd.
Zinc oxide: “Ginrei R” available from Toho Zinc Co., Ltd.
Barium sulfate: “Barium Sulfate BD” available from Sakai Chemical Industry Co., Ltd.
Diphenyl disulfide: available from Sumitomo Seika Chemicals Co., Ltd.
Dicumyl peroxide: “Percumyl (register trademark) D” available from NOF Corporation

### 2. Preparation of Intermediate Layer Composition and Cover Composition

According to the formulations shown in Tables 2 and 3, the materials were mixed with a twin-screw kneading extruder to prepare the intermediate layer composition and the cover composition in a pellet form. The extruding conditions were a screw diameter of 45 mm, a screw rotational speed of 200 rpm, and a screw L/D=35, and the mixture was heated to a temperature of 160° C. to 230° C. at the die position of the extruder.

TABLE 2
Intermediate layer composition

| | | |
|---|---|---|
| Formulation | Himilan AM7337 | 55 |
| (parts by mass) | Himilan AM7329 | 45 |
| | Titanium dioxide | 4 |

| | |
|---|---|
| Hardness (Shore D) | 65 |

Himilan (registered trademark) AM7329: zinc ion-neutralized ethylene-methacrylic acid copolymer ionomer resin available from Dow-Mitsui Polychemicals Co., Ltd.
Himilan AM7337: sodium ion-neutralized ethylene-methacrylic acid copolymer ionomer resin available from Dow-Mitsui Polychemicals Co., Ltd.

TABLE 3
Cover composition

| | | |
|---|---|---|
| Formulation | Elastollan XNY82A | 100 |
| (parts by mass) | Tinuvin 770 | 0.2 |
| | Titanium dioxide | 4 |
| | Ultramarine blue | 0.04 |

| | |
|---|---|
| Hardness (Shore D) | 29 |

Elastollan NY82A: thermoplastic polyurethane elastomer available from BASF Japan Ltd.
TINUVIN 770: hindered amine-based light stabilizer available from BASF Japan Ltd.

### 3. Molding of Intermediate Layer

The above obtained intermediate layer composition was directly injection molded on the above obtained spherical core to form the intermediate layer (thickness: 1.0 mm) covering the spherical core.

### 4. Preparation of Reinforcing Layer

A reinforcing layer composition (trade name “Polin (registered trademark) 750LE” available from Shinto Paint Co. Ltd.) having a two-component curing type epoxy resin as a base resin was prepared. The base material contains 30 parts by mass of a bisphenol A type solid epoxy resin and 70 parts by mass of a solvent. The curing agent contains 40 parts by mass of a modified polyamide amine, 5 parts by mass of titanium dioxide and 55 parts by mass of a solvent. The mass ratio of the base material to the curing agent was 1/1. The reinforcing layer composition was applied to the surface of the intermediate layer with an air gun and kept at an atmosphere of 23° C. for 12 hours, to form the reinforcing layer. The reinforcing layer had a thickness of 7 μm.

### 5. Molding of Cover

The cover composition in a pellet form was charged into each of the depressed part of the lower mold of a half shell molding mold one by one, and applying a pressure to mold half shells. The spherical body having the reinforcing layer formed thereon was concentrically covered with two of the half shells. The spherical body and half shells were charged into a final mold provided with a plurality of pimples on the cavity surface. The cover (thickness: 0.5 mm) was formed by compression molding, and the golf ball bodies were obtained. A plurality of dimples having an inverted shape of the pimples were formed on the cover.

### 6. Preparation of Paint

### Preparation of Urethane Polyols No. 1 to No. 4

According to the formulations shown in Table 4, a polycarbonate diol (PCD 500, PCD 800, PCD 1000) or polytetramethylene ether glycol (PTMG 650) and trimethylolpropane (TMP) were dissolved as the first polyol component in a solvent (toluene and methyl ethyl ketone). Dibutyltin dilaurate was added as a catalyst into the above prepared solution in an amount of 0.1 mass % with respect to 100 mass % of the polyol component. While keeping the temperature of the polyol solution at 80° C., isophorone diisocyanate (IPDI) was added dropwise as the first polyisocyanate component to the polyol solution and mixed. After finishing the addition of isophorone diisocyanate, stirring was continued until the isocyanate group disappeared. Then, the reaction liquid was cooled to the room temperature to prepare the urethane polyol (solid component content: 60 mass %). The composition of the obtained urethane polyol are shown in Table 4.

TABLE 4

| | | Urethane polyol No. | | | |
|---|---|---|---|---|---|
| | Number average | 1 | 2 | 3 | 4 |
| Material | molecular weight | Molar ratio | | | |
| PCD 500 | 500 | 1 | — | — | — |
| PCD 800 | 800 | — | 1 | — | — |
| PCD 1000 | 1000 | — | — | 1 | — |
| PTMG 650 | 650 | — | — | — | 1 |
| TMP | 134.2 | 1.87 | 1.87 | 1.87 | 1.87 |
| IPDI | 222.3 | 1.72 | 1.72 | 1.72 | 1.72 |

| | | | | |
|---|---|---|---|---|
| Amount of polycarbonate diol in urethane polyol (mass %) | 44 | 56 | 61 | — |

The materials used in Table 4 are shown as follows.
PCD 500: polycarbonate diol (number average molecular weight: 500) available from Asahi Kasei Chemicals Corporation
PCD 800: polycarbonate diol (number average molecular weight: 800) available from Asahi Kasei Chemicals Corporation
PCD 1000: polycarbonate diol (number average molecular weight: 1000) available from Asahi Kasei Chemicals Corporation
PTMG 650: polyoxytetramethylene glycol (number average molecular weight: 650) available from Mitsubishi Chemical Corporation
TMP: trimethylolpropane available from Tokyo Chemical Industry Co. Ltd.
IPDI: isophorone diisocyanate available from Sumika Covestro Urethane Company, Ltd.

### Preparation of Polyol Compositions (Base Materials)

A solvent (a mixed solvent of xylene/methyl ethyl ketone=70/30 (mass ratio)) was mixed in an amount of 100 parts by mass with respect to 100 parts by mass of the resin component to prepare the polyol compositions. It is noted that dibutyltin dilaurate was added as a catalyst in an amount of 0.1 mass % with respect to 100 mass % of the resin component in the polyol composition.

### Preparation of Polyisocyanate Compositions (Curing Agent)

According to the formulations shown in Table 5, the polyisocyanates were added to prepare the polyisocyanate compositions.

As the polyisocyanate, the following materials were used.
Isocyanurate-modified product of HDI: isocyanurate-modified product of hexamethylene diisocyanate (Duranate (registered trademark) TKA-100 (NCO amount: 21.7 mass %) available from Asahi Kasei Chemicals Corporation)
Adduct-modified product of HDI: adduct-modified product of hexamethylene diisocyanate (Duranate (registered trademark) E402-80B (NCO amount: 7.3 mass %) available from Asahi Kasei Chemicals Corporation)
Biuret-modified product of HDI: biuret-modified product of hexamethylene diisocyanate (Duranate (registered trademark) 21S-75E (NCO amount: 15.5 mass %) available from Asahi Kasei Chemicals Corporation)
Isocyanurate-modified product of IPDI: isocyanurate-modified product of isophorone diisocyanate (VESTANAT (registered trademark) T1890 (NCO amount: 12.0 mass %) available from Degussa Co., Ltd.)

TABLE 5

| Golf ball No. | | | | 1 | 2 | 3 | 4 | 5 |
|---|---|---|---|---|---|---|---|---|
| Paint film | Formulation | Polyol composition | Urethane polyol No. 1 | 100 | 100 | — | — | — |
| (paint film | | (base material) | (including PCD 500) | | | | | |
| resin) | | | Urethane polyol No. 2 | — | — | 100 | 100 | — |
| | | | (including PCD 800) | | | | | |
| | | | Urethane polyol No. 3 | — | — | — | — | 100 |
| | | | (including PCD 1000) | | | | | |
| | | | Urethane polyol No. 4 | — | — | — | — | — |
| | | | (including PTMG 650) | | | | | |
| | | Polyisocyanate | Isocyanurate-modified | 20 | 30 | 30 | 50 | 30 |
| | | composition | product of HDI | | | | | |
| | | (curing agent) | Adduct-modified product of | 80 | 70 | 70 | 50 | 70 |
| | | | HDI | | | | | |
| | | | Biuret-modified product of | — | — | — | — | — |
| | | | HDI | | | | | |
| | | | Isocyanurate-modified | — | — | — | — | — |
| | | | product of IPDI | | | | | |

| | | | | | | |
|---|---|---|---|---|---|---|
| | Base material/curing agent (mass ratio of solid | 100/52 | 100/55 | 100/39 | 100/33 | 100/35 |
| | components) | | | | | |
| | NCO group included in curing agent/OH group | 1.2 | 1.2 | 1.2 | 1.2 | 1.2 |
| | included in base material (NCO/OH molar ratio) | | | | | |
| Properties | M10 (kgf/cm²) | 20 | 60 | 29 | 81 | 28 |
| | M50 (kgf/cm²) | 40 | 103 | 60 | 129 | 61 |
| | εmax (%) | 50 | 50 | 50 | 50 | 50 |
| | ε1 (%) | 14.3 | 34.7 | 26.0 | 35.2 | 24.5 |
| | ε1/M10 | 0.72 | 0.58 | 0.90 | 0.43 | 0.87 |

| Evaluation of golf ball | Spin rate on approach | 3640 | 3590 | 3630 | 3580 | 3620 |
|---|---|---|---|---|---|---|
| | shots from the rough (rpm) | | | | | |
| | Wear resistance of ball | E | E | E | E | E |
| | surface | | | | | |
| | Stain resistance on shots | E | E | E | E | E |
| | from the bunker | | | | | |

| Golf ball No. | | | | 6 | 7 | 8 | 9 |
|---|---|---|---|---|---|---|---|
| Paint film | Formulation | Polyol | Urethane polyol No. 1 (including | — | — | — | — |
| (paint film | | composition (base | PCD 500) | | | | |
| resin) | | material) | Urethane polyol No. 2 (including | — | — | — | — |
| | | | PCD 800) | | | | |
| | | | Urethane polyol No. 3 (including | 100 | — | — | — |
| | | | PCD 1000) | | | | |
| | | | Urethane polyol No. 4 (including | — | 100 | 100 | 100 |
| | | | PTMG 650) | | | | |
| | | Polyisocyanate | Isocyanurate-modified product of HDI | 50 | 30 | 30 | 30 |
| | | composition | Adduct-modified product of HDI | 50 | — | — | — |
| | | (curing agent) | Biuret-modified product of HDI | — | 30 | 30 | 30 |
| | | | Isocyanurate-modified product of | — | 40 | 40 | 40 |
| | | | IPDI | | | | |

| | | | | | |
|---|---|---|---|---|---|
| | Base material/curing agent (mass ratio of solid | 100/32 | 100/8.7 | 100/9.8 | 100/12 |
| | components) | | | | |
| | NCO group included in curing agent/OH group included in | 1.2 | 0.36 | 0.41 | 0.5 |
| | base material (NCO/OH molar ratio) | | | | |
| Properties | M10 (kgf/cm²) | 66 | 6 | 10 | 27 |
| | M50 (kgf/cm²) | 115 | 11 | 18 | 43 |
| | εmax (%) | 50 | 50 | 50 | 50 |
| | ε1 (%) | 32.4 | 27.1 | 28.0 | 32.7 |
| | ε1/M10 | 0.49 | 4.37 | 2.83 | 1.21 |

| Evaluation of golf ball | Spin rate on approach shots from the | 3570 | 3600 | 3570 | 3520 |
|---|---|---|---|---|---|
| | rough (rpm) | | | | |
| | Wear resistance of ball surface | E | E | G | F |
| | Stain resistance on shots from the | E | F | G | E |
| | bunker | | | | |

### 7. Formation of Paint Film

According to the formulations shown in Table 5, the polyol composition and the polyisocyanate composition were blended to prepare curing type paint compositions. The surface of the golf ball bodies obtained above was treated with sandblast and marked. Then, the paint was applied with a spray gun, and dried for 24 hours in an oven at a temperature of 40° C. to obtain golf balls having a diameter of 42.7 mm and a mass of 45.6 g. The paint film had a thickness of 10±2 μm. In Table 5, the amounts of the polyisocyanate components and polyol components are shown in parts by mass.

The application of the paint was conducted as follows. The golf ball body was placed in a rotating member provided with prongs, and the rotating member was allowed to rotate at 300 rpm. The application of the paint was conducted by spacing a spray distance (7 cm) between the air gun and the golf ball body, and moving the air gun in an up and down direction. The painting interval in the overpainting operation was set to 1.0 second. The application of the paint was conducted under the spraying conditions of overpainting operation: twice, spraying air pressure: 0.15 MPa, compressed air tank pressure: 0.10 MPa, painting time per one application: one second, atmosphere temperature: 20° C. to 27° C., and atmosphere humidity: 65% or less. Evaluation results regarding the obtained golf balls are shown in Table 5.

It is apparent from the results shown in Table 5 that the golf ball according to the present disclosure that comprises, as a paint film resin, a golf ball paint resin satisfying a relationship of 0.10≤ε1/M10≤1.00, wherein a test piece formed from the golf ball paint resin is deformed until a strain of the test piece becomes a predetermined value εmax and then the deformation of the test piece is decreased until a stress of the test piece becomes 0 kgf/cm² in a tensile test, and M10 (kgf/cm²) is a stress at which a strain of the test piece is 10% during increase in the deformation, and ε1 (%) is a strain at which a stress of the test piece is 0 kgf/cm² during decrease in the deformation, has improved spin performance on approach shots (particularly improved spin performance on approach shots from the rough), excellent ball surface wear resistance, and excellent stain resistance on shots from the bunker.

The preferable embodiment (1) of the present disclosure is a golf ball paint resin satisfying a relationship of 0.10≤ε1/M10≤1.00, wherein a test piece formed from the golf ball paint resin is deformed until a strain of the test piece becomes a predetermined value εmax and then the deformation of the test piece is decreased until a stress of the test piece becomes 0 kgf/cm² in a tensile test conducted under the following test conditions, and M10 (kgf/cm²) is a stress at which a strain of the test piece is 10% during increase in the deformation, and ε1 (%) is a strain at which a stress of the test piece is 0 kgf/cm² during decrease in the deformation.

### Test Conditions

dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%)

The preferable embodiment (2) of the present disclosure is the golf ball paint resin according to the embodiment (1), comprising a polyurethane as a resin component.

The preferable embodiment (3) of the present disclosure is the golf ball paint resin according to the embodiment (2), wherein the polyurethane includes at least one member selected from the group consisting of a polyether diol, a polyester diol, a polycaprolactone diol and a polycarbonate diol as a polyol component.

The preferable embodiment (4) of the present disclosure is the golf ball paint resin according to the embodiment (2) or (3), wherein the polyurethane includes a polycarbonate diol as a polyol component.

The preferable embodiment (5) of the present disclosure is the golf ball paint resin according to any one of the embodiments (2) to (4), wherein the polyurethane includes at least one member selected from the group consisting of an isocyanurate-modified product of hexamethylene diisocyanate, an adduct-modified product of hexamethylene diisocyanate, a biuret-modified product of hexamethylene diisocyanate and an isocyanurate-modified product of isophorone diisocyanate as a polyisocyanate component.

The preferable embodiment (6) of the present disclosure is the golf ball paint resin according to any one of the embodiments (2) to (5), wherein the polyurethane includes a hexamethylene diisocyanate as a polyisocyanate component.

The preferable embodiment (7) of the present disclosure is the golf ball paint resin according to any one of the embodiments (2) to (6), wherein the polyurethane includes an isocyanurate-modified product of hexamethylene diisocyanate and an adduct-modified product of hexamethylene diisocyanate as a polyisocyanate component.

The preferable embodiment (8) of the present disclosure is a golf ball comprising a golf ball body and a paint film composed of at least one layer and formed on a surface of the golf ball body, wherein at least an outermost layer of the paint film is formed from the golf ball paint resin according to any one of the embodiments (1) to (7).

This application is based on Japanese patent application No. 2024-077299 filed on May 10, 2024, the content of which is hereby incorporated by reference.

1. A golf ball paint resin satisfying a relationship of 0.10≤ε1/M10≤1.00, wherein a test piece formed from the golf ball paint resin is deformed until a strain of the test piece becomes a predetermined value εmax and then the deformation of the test piece is decreased until a stress of the test piece becomes 0 kgf/cm² in a tensile test conducted under the following test conditions, and M10 (kgf/cm²) is a stress at which a strain of the test piece is 10% during increase in the deformation, and ε1 (%) is a strain at which a stress of the test piece is 0 kgf/cm² during decrease in the deformation,
<test conditions>
dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%).

2. The golf ball paint resin according to claim 1, comprising a polyurethane as a resin component.

3. The golf ball paint resin according to claim 2, wherein the polyurethane includes at least one member selected from the group consisting of a polyether diol, a polyester diol, a polycaprolactone diol and a polycarbonate diol as a polyol component.

4. The golf ball paint resin according to claim 2, wherein the polyurethane includes a polycarbonate diol as a polyol component.

5. The golf ball paint resin according to claim 2, wherein the polyurethane includes at least one member selected from the group consisting of an isocyanurate-modified product of hexamethylene diisocyanate, an adduct-modified product of hexamethylene diisocyanate, a biuret-modified product of hexamethylene diisocyanate and an isocyanurate-modified product of isophorone diisocyanate as a polyisocyanate component.

6. The golf ball paint resin according to claim 2, wherein the polyurethane includes a hexamethylene diisocyanate as a polyisocyanate component.

7. The golf ball paint resin according to claim 2, wherein the polyurethane includes an isocyanurate-modified product of hexamethylene diisocyanate and an adduct-modified product of hexamethylene diisocyanate as a polyisocyanate component.

8. The golf ball paint resin according to claim 2, wherein the polyurethane is a product obtained by a reaction between a polyisocyanate composition containing a polyisocyanate and a polyol composition containing a polyol.

9. The golf ball paint resin according to claim 8, wherein the polyol composition contains a urethane polyol as the polyol, and the urethane polyol includes a polycarbonate diol as a polyol component.

10. The golf ball paint resin according to claim 9, wherein the polycarbonate diol has a number average molecular weight ranging from 400 to 1200.

11. A golf ball comprising a golf ball body and a paint film composed of at least one layer and formed on a surface of the golf ball body, wherein an outermost layer of the paint film is formed from a golf ball paint resin satisfying a relationship of 0.10≤ε1/M10≤1.00, wherein a test piece formed from the golf ball paint resin is deformed until a strain of the test piece becomes a predetermined value εmax and then the deformation of the test piece is decreased until a stress of the test piece becomes 0 kgf/cm² in a tensile test conducted under the following test conditions, and M10 (kgf/cm²) is a stress at which a strain of the test piece is 10% during increase in the deformation, and ε1 (%) is a strain at which a stress of the test piece is 0 kgf/cm² during decrease in the deformation,
<test conditions>
dimension of test piece: width of 4 mm and thickness of 100 μm±10 μm
distance between clamps: 20 mm
measuring temperature: 23° C.
tensile speed during increase in the deformation: 1.1 mm/second
returning speed during decrease in the deformation: 1.1 mm/second
load data acquisition points per second: 50
strain setting value: 10 mm (εmax=50%).

12. The golf ball according to claim 11, wherein the golf ball paint resin comprises a polyurethane as a resin component.

13. The golf ball according to claim 12, wherein the polyurethane includes at least one member selected from the group consisting of a polyether diol, a polyester diol, a polycaprolactone diol and a polycarbonate diol as a polyol component.

14. The golf ball according to claim 12, wherein the polyurethane includes a polycarbonate diol as a polyol component.

15. The golf ball according to claim 12, wherein the polyurethane includes at least one member selected from the group consisting of an isocyanurate-modified product of hexamethylene diisocyanate, an adduct-modified product of hexamethylene diisocyanate, a biuret-modified product of hexamethylene diisocyanate and an isocyanurate-modified product of isophorone diisocyanate as a polyisocyanate component.

16. The golf ball according to claim 12, wherein the polyurethane includes a hexamethylene diisocyanate as a polyisocyanate component.

17. The golf ball according to claim 12, wherein the polyurethane includes an isocyanurate-modified product of hexamethylene diisocyanate and an adduct-modified product of hexamethylene diisocyanate as a polyisocyanate component.

18. The golf ball according to claim 12, wherein the polyurethane is a product obtained by a reaction between a polyisocyanate composition containing a polyisocyanate and a polyol composition containing a polyol.

19. The golf ball according to claim 18, wherein the polyol composition contains a urethane polyol as the polyol, and the urethane polyol includes a polycarbonate diol as a polyol component.

20. The golf ball according to claim 19, wherein the polycarbonate diol has a number average molecular weight ranging from 400 to 1200.
